(19) United States
(12) Patent Application Publication
(10) Pub. No.: US 2017/0116889 A1
(43) Pub. Date: Apr. 27, 2017

(54) Printable Coating for Woven Fabrics

(71) Applicant: Brady Worldwide, Inc., Milwaukee, WI (US)

(72) Inventor: Matthew M. Kasper, Oak Creek, WI (US)

(21) Appl. No.: 15/178,810

(22) Filed: Jun. 10, 2016

Related U.S. Application Data
(60) Provisional application No. 62/247,046, filed on Oct. 27, 2015.

(51) Int. Cl. G09F 3/00; G09F 3/02; C09D 7/12; C09D 167/00; C09D 133/04

(52) U.S. Cl. CPC G09F 3/005; C09D 167/00; C09D 133/04; C09D 7/1216; G09F 3/02; C08K 3/36

(57) ABSTRACT

A coating composition for a woven fabric comprising, in weight percent (wt %) based on the dry weight of the composition:
(A) 45 to 94 wt % of at least one of a polyester or acrylic resin;
(B) 3 to 15 wt % uncoated amorphous silica; and
(C) 3 to 40 wt % of an inorganic powder with a mean particle size of less than or equal to (≦) 15 microns (μm) and an oil absorption value greater than or equal (≦) 15 milliliters per 100 grams (mL/100 g) of powder.
   The coated fabric is suitable for printing with a laser printer and for wearing as an identification label, e.g., as a wrist or ankle band.

### FIELD OF THE INVENTION

This invention relates to printable coatings, particularly laser printable coatings. In one aspect the invention relates to printable coatings for woven fabrics while in another aspect, the invention relates to printed identification wrist and ankle bands, particularly such bands for use in medical facilities.

### BACKGROUND OF THE INVENTION

Identification bands, e.g., wristbands, ankle bands, etc., are commonly used in hospitals, and typically contain the patient's name, date of birth and a linear or 2-dimensional barcode. The identification information is typically printed onto the band in a laser toner or direct thermal printer at the time the patient checks into the hospital, and frequently a sheet of an accompanying series of labels is printed with the same information at the same time the band is printed The current identification bands are made from a variety of printable materials either as part of a form or as a continuous roll of bands that contain a perforation strip.

Identification bands are described in various United States patent documents, e.g., U.S. Pat. No. 5,653,472, U.S. Pat. No. 7,765,728, US 2008/0309065, US 2011/0131854, and US 2013/0145663. These documents all describe a form with a printable band area that is applied to a liner layer and die cut into the appropriate dimensions. These bands also contain adhesive/release areas that allow for printability and removability from the form.

Since identification bands and other identification material in a healthcare facility may be exposed to liquids and subjected to physical contact, the printed information must remain readable despite periodic moistening and contact. Existing bands address this issue by employing plastic in the identification band. The problem with plastic bands is that their sharp edges irritate sensitive skin, become uncomfortable under extended wear for any user, and may crease to such an extent that human readable and/or machine readable information becomes difficult to read. Additionally, bands that incorporate laminate layovers require complex, time consuming manipulation by the healthcare worker.

Some patients remain in a healthcare facility for an extended time, and many of these patients have sensitive skin. For example, infants, the elderly, and burn patients may spend several weeks or months in a healthcare facility. Proper identification is essential to ensure proper care during their stay. Existing soft bands may be made of fabric that imparts greater softness than plastic bands. The problem with fabric bands is that they have low receptivity to printing, in particular, laser printing. Coatings to improve printability leave fabrics too stiff for use to manufacture a comfortable band, and have poor abrasion and chemical resistance. Additionally, fabric bands require reinforced identification regions in order to support printability and the readability of identifying information. Such reinforcement measures may include fold over flaps, and fold over laminates; both requiring complex, time consuming manipulation by the healthcare worker. As such, of continuing interest is the development of an identification band that can be worn comfortably by all patients for extended periods of time, is laser printable, and durable.

### SUMMARY OF THE INVENTION

In one embodiment the invention is a coating composition comprising, in weight percent (wt %) based on the dry weight of the composition:
(A) 45 to 94 wt % of at least one of a polyester or acrylic resin;
(B) 3 to 15 wt % uncoated amorphous silica; and
(C) 3 to 40 wt % of an inorganic powder with a mean particle size of less than or equal to (≦) 15 microns (μm) and an oil absorption value greater than or equal (≦) 15 milliliters per 100 grams (mL/100 g) of powder.

In one embodiment the invention is a woven fabric coated with a composition comprising, in weight percent based on the dry weight of the composition:
(A) 45 to 94 wt % of at least one of a polyester or acrylic resin;
(B) 3 to 15 wt % uncoated amorphous silica; and
(C) 3 to 40 wt % of an inorganic powder with a mean particle size of ≦15 μm and an oil absorption value≧15 mL/100 g of powder.

In one embodiment the invention is an label comprising a woven fabric coated with a composition comprising, in weight percent (wt %) based on the dry weight of the composition:
(A) 45 to 94 wt % of at least one of a polyester or acrylic resin;
(B) 3 to 15 wt % uncoated amorphous silica; and
(C) 3 to 40 wt % of an inorganic powder with a mean particle size of ≦15 μm and an oil absorption≧15 mL/100 g of powder.

In one embodiment the label is an identification label for humans or other animals. In one embodiment the label is a wrist or ankle band for humans in a medical facility.

### DETAILED DESCRIPTION OF THE PREFERRED EMBODIMENT

### Definitions

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

Unless stated to the contrary, implicit from the context, or customary in the art, all parts and percents are based on weight.

Numerical ranges include all values from, and including, the lower and upper value. For ranged containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

### Polyester and Acrylic Resins

Any polyester or acrylic resin that can received and hold an image delivered from a laser printer, act as a binder for the silica and inorganic powder particles, and is both abrasion resistant and resistant to both aqueous- and organic-based liquids, can be used in the practice of this invention. Typical and preferred polyester and acrylic resins are amorphous and have a molecular weight of at least 6,000 grams per mole (g/mol) and a glass transition temperature from 40 to 80° C. VYLON™ 103 is a nonlimiting example of the polyester resins that can be used in the practice of this invention, and DIANAL™ BR-53 is a nonlimiting example of the acrylic resins that can be used in the practice of this invention. Both the polyester resin and the acrylic resin can be used alone, or the resins can be used in combination with one another. Preferably one or the other resin is used in the absence of the other, and the polyester resins are preferred over the acrylic resins. The resin component of the coating composition of this invention can comprises two or more polyester resins and/or two or more acrylic resins. The total amount of polyester and/or acrylic resin in the coating composition, on a dry weight basis, is from 45 to 94 wt %, or from 50 to 80 wt %.

### Amorphous Silica

The amorphous silica (SiO₂) used in the practice of this invention is a particulate and is uncoated, i.e., it does comprise a surface treatment, and it has a large absorption capacity which is commonly defined by their oil absorption value. The silica particles have an oil absorption value greater than (>) 150, preferably >250 and more preferably >300, grams of oil per 100 grams of silica (g oil/100 g silica). In one embodiment the oil absorption value correlates to a specific pore volume of at least 1.2, preferably at least 1.5 and more preferably at least 1.8, cubic centimeters per gram (cm³/g). Generally, the higher the oil absorption, the more preferred the silica although as a practical matter, the oil absorption value does not exceed 3 cm³/g. The method for measuring the oil absorption value is set forth in ASTM D281-95.

The amorphous silica that can be used in the practice of this invention include, but are not limited to, SYLOJET™ A25, SYLOJET™ C30, SYLOJET™ 710A, SYLOJET™ 710C, SYLOJET™ C803, and SYLOJET™ P403 available from W.R. Grace; and SYLYSIA™ 310P, SYLYSIA™ 320, SYLYSIA™ 350, SYLYSIA™ 420, SYLYSIA™ 530 available from Fuji Sylysia. Two particularly preferred silicas for the base layer are SYLOID™ C812 and SYLOJET™ P412 which have an oil absorption value of 320 g oil/100 g silica and a mean particle size of 12 microns (measured by laser diffraction). Preferred silicas for the imaging layer include SYLOJET™ A25, SYLOJET™ C30, SYLOJET™ 710A, SYLOJET™ 710C, SYLYSIA™ 310P, SYLYSIA™ 320, and SYLYSIA™ 350. In general, a silica with large particle size and narrow particle size distribution gives a coating with more inter-particle void space and better ink absorption than a silica with a small particle size and/or broad particle size distribution. The amorphous silica in the coating compositions of this invention can comprise a single silica or a combination of silicas, although it typically comprises a single silica, preferably SYLYSIA™ 350 silica.

The mean particle size of the amorphous silica used in the practice of this invention is typically less than or equal to (≦) 15 μm, or 12 μm, or 10 μm, or 8 μm. Mean particle size can be measured by any conventional means, e.g., dynamic light scattering.

The total amount of amorphous silica in the coating composition, on a dry weight basis, is from 3 to 15 wt %, or from 5 to 15 wt %, or from 10 to 15 wt %.

### Inorganic Powders

The inorganic powders used in the practice of this invention include metal powders, ceramic powders and the like. Examples of specific inorganic powders that can be used include metal oxide powders such as titanium dioxide, zirconia, zinc oxide, calcium oxide, potassium titanate, aluminum borate, kaolin, borax and the like. Also useful are the metal carbonates, e.g., calcium carbonate. Preferred inorganic powders include calcium carbonate, particularly precipitated calcium carbonate, titanium dioxide and zinc oxide. The inorganic powder in the coating compositions of this invention can comprise a single powder or a combination of powders, although it typically comprises a single powder, preferably precipitated calcium carbonate such as ALBACAR™ 5970 or a titanium dioxide such as TI-PURE™ R-960 or TS-6200.

The inorganic powders have a mean particle size less than or equal to (≦) 15 μm, or 12 μm, or 10 μm, or 8 μm. Mean particle size can be measured by any conventional means, e.g., dynamic light scattering.

The inorganic powders have an oil absorption value greater than (>) 15, or 25, or 50, or 100, or 150, or 200, or 250, or 300, g oil/100 g powder.

The total amount of inorganic powder in the coating composition, on a dry weight basis, is from 3 to 40 wt %, or from 10 to 40 wt %, or from 20 to 40 wt %, or from 30 to 40 wt %.

### Compounding

The coating composition of this invention is compounded using known equipment and techniques. The silica and inorganic powder are typically first blended with one another, and then the binder resin is folded into the blend of silica and inorganic powder. The resulting mixture is then mixed until it is homogeneous. Conventional solvents can be used to facilitate the compounding and eventual application of the coating to the fabric.

### Woven Fabric

The woven fabric used in the practice of this invention can be made of various materials, both natural and synthetic. The woven material can be, for example, polyethylene terephthalate (“PET”), biaxially oriented polypropylene (“BOPP”), a 50 to 100 denier polyester, nylon, or a blend fabric, to which a coating (other than the inventive coating), e.g., an acrylic can first be applied to seal the sheet of material, e.g., woven material, and improve and/or impart desired properties, e.g., abrasion and/or solvent resistance, tensile strength, etc. Examples of woven material, e.g., WORTHEN™ PS500W, that can be used in the substrate layer are available from, for example, Worthen Industries of Nashua, N.H.

The coating composition of this invention is applied to the woven fabric using conventional techniques and equipment, e.g., gravure or flexographic printing. The amount of coating applied to the fabric can vary, but typically the minimum amount is one pound per ream (lb/rm) dry weight, or from 5 to 10 lb/rm.

### Fabric Labels

After the coating composition is applied to the woven fabric, the coated fabric is allowed to dry. The coated fabric is then processed by know methods using know equipment into various articles of manufacture. The coated fabric is suitable for printing by laser printer, and the applied coating composition exhibits very desirable ink or toner retention, abrasion resistance and resistance to water- and organic-based solvents. The methods for the manufacture of identification labels such as wrist and ankle bands are well known in the art, e.g., U.S. Pat. No. 7,810,267 and U.S. Pat. No. 8,061,069, and US 2012/0175424, 2013/0056974 and 2013/0145663.

What is claimed is:

1. A coating composition comprising, in weight percent (wt %) based on the dry weight of the composition:
(A) 45 to 94 wt % of at least one of a polyester or acrylic resin;
(B) 3 to 15 wt % uncoated amorphous silica; and
(C) 3 to 40 wt % of an inorganic powder with a mean particle size of less than or equal to (≦) 15 microns (μm) and an oil absorption value greater than or equal (≧) 15 milliliters per 100 grams (mL/100 g) of powder.

2. The coating composition of claim 1 in which the silica has an oil absorption value greater than (>) 150 g oil/100 g silica.

3. The coating composition of any of the preceding claims in which the silica has a mean particle size of less than or equal to 15 μm.

4. The coating composition of any of the preceding claims in which the inorganic powder is a metal oxide or metal carbonate.

5. The coating composition of any of the preceding claims in which the inorganic powder is a precipitated calcium carbonate, or a titanium dioxide, or a zinc oxide.

6. A woven fabric comprising the coating composition of any of the preceding claims.

7. The woven fabric of claim 6 in the form of an identification label.

8. The identification label of claim 7 in the form of a wrist or ankle band.
